(19) United States
(12) Patent Application Publication
(10) Pub. No.: US 2015/0138681 A1
(43) Pub. Date: May 21, 2015

(54) SOLID STATE POWER CONTROLLER FOR AN AIRCRAFT

(71) Applicant: Julian Peter MAYES, Cheltenham (GB)

(72) Inventor: Julian Peter MAYES, Cheltenham (GB)

(21) Appl. No.: 14/543,531

(22) Filed: Nov. 17, 2014

(30) Foreign Application Priority Data
Nov. 20, 2013 (GB) 1320500.0

(51) Int. Cl. B64D 41/00; H02H 1/00; H02H 3/08

(52) U.S. Cl. CPC B64D 41/00; H02H 3/08; H02H 1/0007; B64D 2221/00
USPC 361/93.7

(57) ABSTRACT

A solid state power controller for an aircraft. The solid state power controller includes a solid state switching device for activating an electrical power output bus, a control unit for controlling the solid state switching device, and a current sensing circuit for monitoring current flowing in the electrical power output bus. The current sensing circuit includes a sensing fuse.

### FIELD OF THE INVENTION

Embodiments of the present invention relate generally to solid state power controllers (SSPCs) for aircraft. More particularly, embodiments of the present invention relate to an improved device for protecting solid state power controllers of the type that are used in aircraft.

### BACKGROUND

Solid state power controllers are known for use in various aircraft power systems [1-6].

However, recent industry and certification guidelines have highlighted a requirement that all such SSPCs should have a secondary failsafe isolation mechanism in the event of failure of the primary switching device provided therein, typically a field-effect transistor (FET).

One approach to provide such a secondary failsafe isolation mechanism is to use a FET cell device to control current flow during normal operation and limit it during fault conditions. Such a FET cell device is depicted in FIG. 1.

In the FET cell device of FIG. 1 a power input line 12 is connected to the drain of a FET 10. The source of the FET 10 is connected to a low value sense resistor 40 at a first end thereof and a first input terminal of an operational amplifier 30. A second input terminal of the operational amplifier 30 is connected to a second end of the sense resistor 40, such that the operational amplifier 30 can provide a signal at an output thereof indicative of voltage variations across the sense resistor 40 induced by a current flowing through the FET 10.

The second end of the sense resistor 40 is also connected in series to a power output line 60 through a fuse 50. The power output line 60 may be used in an aircraft to drive various electrical loads that are connected thereto.

The output of the operational amplifier 30 is connected to a control unit 20, and control unit 20 further connects to the gate of the FET 10. The control unit 20 is operable to switch the FET 10 on and off.

The FET cell device thus provides an internal current measurement system used in a control loop for regulating the current drawn from the power input line 12 by the loads connected to the power output line 60 during normal operation.

In the event that the FET 10 fails to provide a short circuit between the source and the drain, or the control loop fails to effectively enable the same, then the current drawn by the loads may increase beyond the rated current for the fuse 50 and cause it to blow. Thus the FET cell device also provides the required secondary failsafe isolation mechanism.

Whilst the known conventional FET cell device described above provides a suitable solution to the current industry and certification requirements, any improvements thereto would be welcomed in the art.

### SUMMARY

Accordingly, various aspects and embodiments of the present invention have been developed by the inventor.

According to a first aspect of the present invention, there is thus provided a solid state power controller for an aircraft, comprising a solid state switching device for activating an electrical power bus, a control unit for controlling the solid state switching device, and a current sensing circuit for monitoring current flowing in the electrical power bus. The current sensing circuit also includes a novel sensing fuse that combines the functions of both a sense resistor and a fuse in a single component.

By using such a sensing fuse, component count and heat dissipation are both reduced in a solid state power controller, leading to improved circuit electrical efficiency, improved operating reliability and a weight and volume reduction.

Various additional advantages will become apparent to those skilled in the art when considering the various embodiments of the present invention that are described below.

### BRIEF DESCRIPTION OF THE DRAWINGS

Various aspects and embodiments of the present invention will now be described in connection with the accompanying drawings, in which:

FIG. 1 shows a conventional solid state power controller using a FET cell device;

FIG. 2 shows a solid state power controller in accordance with various embodiments of the present invention;

FIG. 3 shows a detailed view of an aircraft solid state power controller system in accordance with an embodiment of the present invention; and

FIG. 4 shows a sensing fuse for use in various embodiments of the present invention.

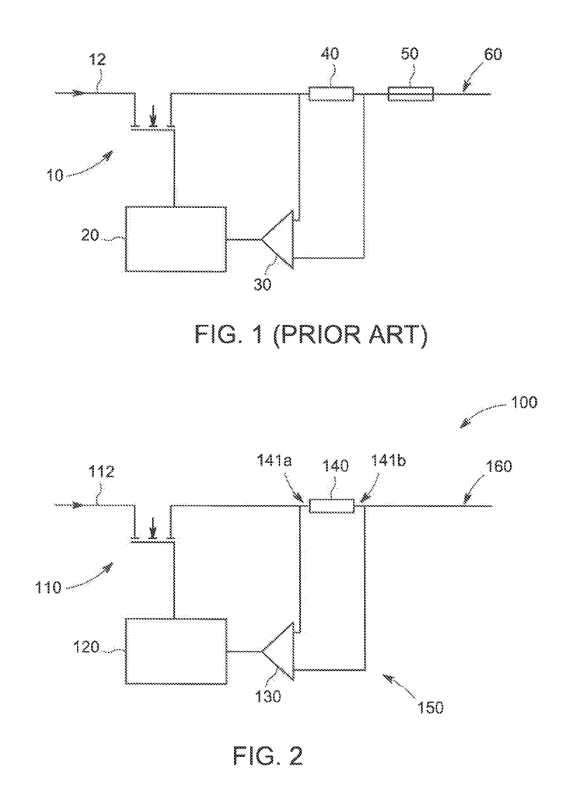

### DETAILED DESCRIPTION

FIG. 2 shows a solid state power controller 100 in accordance with various embodiments of the present invention.

The solid state power controller 100 is of the FET cell device type, and includes a power input line 112 connected in series to a FET 110, a current sensing and protection circuit 150, and then to an electrical power output bus 160. The electrical power output bus 160 may be used in an aircraft to drive various electrical loads that are connected thereto.

The FET 110 is controlled by a control unit 120 that derives a current sensing signal from the current sensing and protection circuit 150, and is operable to activate the electrical power output bus 160. The current sensing and protection circuit 150 comprises a sensing fuse 140 and a sensor amplifier 130.

The power input line 112 is connected to a source terminal of the FET 110. A drain terminal of the FET 110 is connected to a first input terminal of the sensor amplifier 130 and a first terminal 141a of the sensing fuse 140. The sensing fuse 140 is connected in series between the source terminal of the FET 110 and the electrical power output bus 160. A second input terminal of the sensor amplifier 130 is connected to both the electrical power output bus 160 and a second terminal 141b of the sensing fuse 140.

An output from the sensor amplifier 130 is fed into the control unit 120 as the current sensing signal. The control unit 120 is then operable to control the FET 110 by applying a voltage signal to a gate of the FET 110 in response to this current sensing signal. For example, the control unit 120 is operable to switch the FET 110 on and off.

Over a normal operating current range, the sensing fuse 140 has a substantially constant resistance that enables it to act as sensor. The voltage across the sensing fuse 140, generated by a current flowing through the FET 110 to the loads, is amplified by the sensor amplifier 130 and is substantially proportional thereto.

However, should the sensing fuse 140 be operated outside of the normal operating current range it behaves as a fuse rather than a sensor. Excess current causes the sensing fuse 140 to blow, e.g. either by tripping or resistive heating.

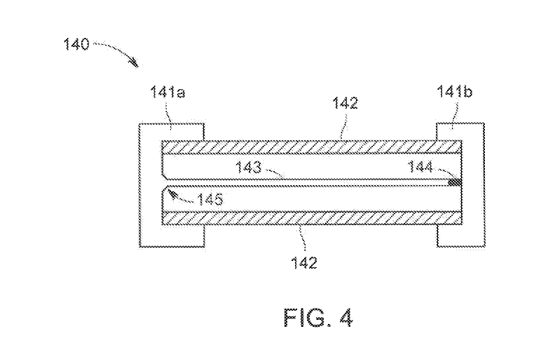

Various sensing fuses are envisaged, such as that described below in connection with FIG. 4 for example. However, they all have specifically tailored non-linear current responses that enable a single device to act as both a resistive sensor and a fuse depending on the current they carry.

For example, a sensing fuse may be provided that provides a substantially stable resistance up to an operating temperature of about 100° C. Such a fuse is designed such that, should it rupture, debris would be contained therein.

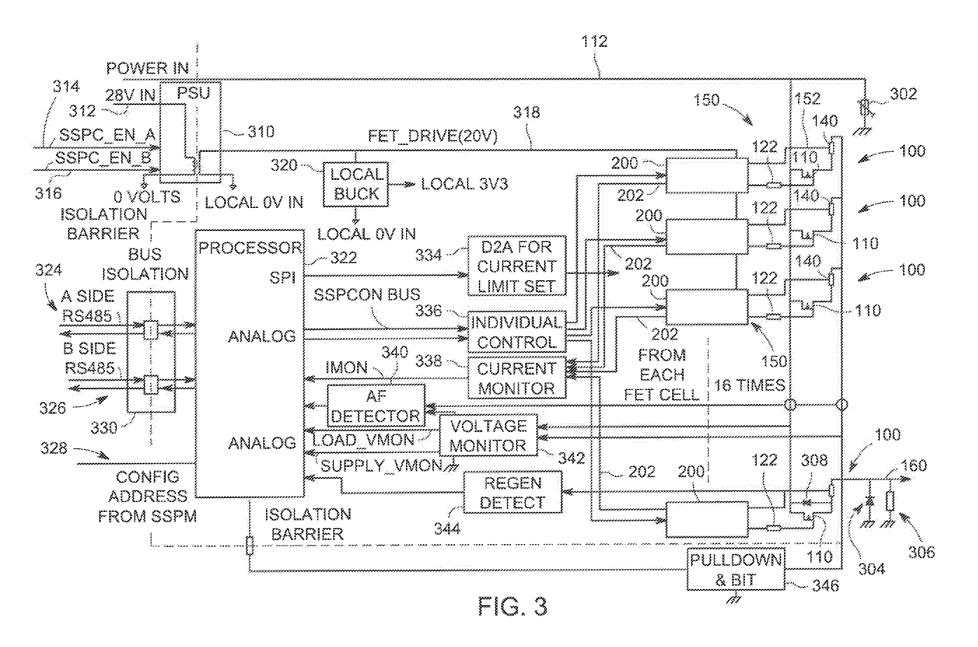

FIG. 3 shows a detailed view of an aircraft solid state power controller system 300 in accordance with an embodiment of the present invention. The aircraft solid state power controller system 300 comprises a plurality of solid state power controllers 100 of the type shown in FIG. 2 connected in parallel. In the embodiment of FIG. 3, sixteen such solid state power controllers 100 are provided, although those skilled in the art will be aware that such a number is not in any way limiting. By connecting the solid state power controllers 100 in parallel, higher current levels can be achieved.

Each solid state power controller 100 includes a respective pair of sense lines 152 connected across a respective sensing fuse 140 and to associated sensor amplifiers 130. Respective control units 120 include a respective FET control and current limit circuit 200 (also known as an FET control cell) and gate resistor 122 coupled to the gates of respective FETs 110.

The power input line 112 is connected to ground via transient suppression circuitry 302. Electrical power output bus 160 is electrically coupled to ground via both a flywheel diode 304 and a passive pulldown 306. A reverse biased diode 308 is provided in parallel between the gate and drain of at least one of the FETs 110 to provide back-EMF protection thereto.

A power supply unit 310 is provided in the aircraft solid state power controller system 300. A 28 volt AC power input feeds a transformer in the power supply unit 310 which may be enabled to operate by first and second SSPC enable lines 314, 316. A 20 volt supply is generated on an output line 318 of the power supply unit 310 and is used to supply power to the FET control cells 200 and a local buck converter 320 used to generate a local 3.3 volt supply.

A processor 322 is provided to manage the settings of the aircraft solid state power controller system 300, as well as to monitor the operation thereof. External communications are provided to and from the processor by first and second RS485 communications buses 324 and 326 as well as though a configuration address bus 328. Alternative embodiments may use communications buses other than RS485.

The processor 322 controls a digital-to-analogue converter 334 used to set the current limits of respective of the FET control cells 200. A control unit 336 is also connected to the processor 322 and is used to set the ON/OFF state of each respective solid state power controller 100.

Each FET control cell 200 is connected to a current monitor unit 338. This unit 338 is configured to generate a signal that is fed back to the processor 322 which is then used to monitor the overall current of the aircraft solid state power controller system 300.

A voltage monitor unit 342 is also provided coupled between the power input line 112 and the electrical power output bus 160. The voltage monitor unit 342 is additionally configured to generate various signals that are fed back to the processor 322 to use as inputs for the control algorithm used therein.

Additionally, monitoring of the FET control cells 200 is provided by an arc fault (AF) detector 340 and a regeneration detector 344. The regeneration detector 344 is operable to detect a regenerative current when current flow is reversed and flows from the output to the input.

A pulldown and BIT circuit 346 connects the processor 322 to the electrical power output bus 160. The pulldown circuit component ensures that the output voltage is kept to a reasonable level when the FET switches 110 are off. The BIT circuit component provides a built-in test (BIT) function that ensures each individual FET 110 is working as expected.

FIG. 4 shows a sensing fuse 140 for use in various embodiments of the present invention. The sensing fuse 140 has first and second terminals 141a, 141b for connecting the sensing fuse 140 to external circuitry. In various embodiments, a sensing fuse 140 can be provided having a resistance, for example, of from about 3 to about 5 milli-Ohms (mQ) with a tolerance of 2% or better over an operating temperature range of up to about 100° C.

In the depicted embodiment, the first and second terminals 141a, 141b are substantially cup-shaped metallic parts of the type known in the art of fuse manufacturing. For example, the cup-shaped metallic parts may form part of a standard cartridge fuse. They may thus also be sized so as to fit into a standard fuse holder.

The first and second terminals 141a, 141b are separated from one another and supported by a cylindrical casing 142. The casing may be made of glass, ceramic or other insulating material, as is known in the art.

The first terminal 141 a of the sensing fuse 140 is connected to a first end of a fuse wire 143 by way of a joint 145. In various embodiments, the joint 145 is a brazed joint (e.g. formed by heating at above 270° C.) provided between the first terminal 141 a and the fuse wire 143. Alternatively, the joint 145 may be formed by high temperature soldering of the first terminal 141a and the fuse wire 143. For example, soldering using high temperature solders such as gold (Au), gold-tin (AuSn), gold-silicon (AuSi), and gold-germanium (AuGe) may be used.

A second end of the fuse wire 143 is connected to the second terminal 141b of the sensing fuse 140 by way of a further joint 144. More particularly, the joint 144 is formed using a low-temperature solder. For example, a low-temperature solder having a melting point from about 50° C. to about 150° C. may be used. Examples of such low temperature solders may include indium-containing and bismuth-containing alloys; such as bismuth-tin (BiSn) provided in various proportions.

The sensing fuse 140 thus provides a two-component fusing element. One element provides substantially all of the thermal fuse action (e.g. the solder joint 144) and the other element substantially all of the resistance in the normal current operating range (e.g. the fuse wire 143). Careful choice of the elements and the materials they are made from provides the desired non-linear current response.

In various embodiments the fuse wire 143 comprises a high melting point material such as copper or a copper alloy. Such fuse wire has relatively little temperature change when operated over a relatively low current range compared to the rated value. For example, where the fuse wire 143 is operated over 10% of its rated current the resistive heating thereof does not alter the resistance of the sensing fuse 140 significantly enough to affect its performance as a sensing element. Additionally, the fuse wire has a high melting point (e.g. copper melts at about 1085° C.). Hence, when operated outside of its normal operating range (e.g. outside of 0-10% of rated value) the fuse wire 143 will heat up, but not significantly close to its own melting temperature, whilst the solder will melt at well-defined and much lower temperature to provide a fusing action and an open circuit.

Thus various embodiments of sensing fuses may be provided that combine the functions of a sensing resistor and fuse in a single unitary component, whilst simultaneously reducing the waste heat produced as compared to conventional devices that use both a sense resistor and a separate fuse.

Those skilled in the art will be aware that many different embodiments of solid state power controllers are possible. For example, whilst embodiments of the present invention are described in connection with FET control cells, those skilled in the art will be aware that the invention is not limited thereto and that various non-FET based solid state power controllers may be provided.

Those skilled in the art will also realise various embodiments of aircraft power supply and/or solid state power controller systems may be made which use such solid state power controllers.

In addition, whilst specific embodiments of a sensing fuse have been described in connection with FIG. 4, various such sensing fuses will be apparent to those skilled in the art having read the teachings herein. For example, a portion of fuse wire might be joined to each of the first and second terminals by respective high temperature joints with the distal ends thereof being joined by a third low-temperature joint provided somewhere between the first and second terminals. Alternative sensing fuse arrangements will also be apparent.

All such embodiments, including any method equivalents thereof, are intended to fall within the spirit and scope of the appended claims.

This written description uses examples to disclose the invention, including the preferred embodiments, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A solid state power controller for an aircraft, comprising:
a solid state switching device for activating an electrical power bus;
a control unit for controlling the solid state switching device; and
a current sensing and protection circuit for monitoring current flowing in the electrical power bus, the current sensing circuit including a sensing fuse.

2. The solid state power controller of claim 1, wherein the current sensing and protection circuit further comprises a sensor amplifier for providing a sense signal to the control unit.

3. The solid state power controller of claim 1, wherein the sensing fuse comprises a fuse wire element electrically and thermally connected to a solder joint.

4. The solid state power controller of claim 2, wherein the sensing fuse comprises a fuse wire element electrically and thermally connected to a solder joint.

5. The solid state power controller of claim 3, wherein the fuse wire element comprises copper or a copper alloy.

6. The solid state power controller of claim 3, wherein the solder joint comprises a low-temperature solder having a melting point from about 50° C. to about 150° C.

7. The solid state power controller of claim 5, wherein the solder joint comprises a low-temperature solder having a melting point from about 50° C. to about 150° C.

8. An aircraft solid state power controller system comprising a plurality of solid state power controllers comprising:
a solid state switching device for activating an electrical power bus;
a control unit for controlling the solid state switching device; and
a current sensing and protection circuit for monitoring current flowing in the electrical power bus, the current sensing circuit including a sensing fuse.

9. The aircraft solid state power controller system of claim 8, wherein the current sensing and protection circuit further comprises a sensor amplifier for providing a sense signal to the control unit.

10. The aircraft solid state power controller system of claim 8, wherein the sensing fuse comprises a fuse wire element electrically and thermally connected to a solder joint.

11. The aircraft solid state power controller system of claim 9, wherein the sensing fuse comprises a fuse wire element electrically and thermally connected to a solder joint.

12. The aircraft solid state power controller system of claim 10, wherein the fuse wire element comprises copper or a copper alloy.

13. The aircraft solid state power controller system of claim 10, wherein the solder joint comprises a low-temperature solder having a melting point from about 50° C. to about 150° C.

14. The aircraft solid state power controller system of claim 12, wherein the solder joint comprises a low-temperature solder having a melting point from about 50° C. to about 150° C.

15. A method of controlling a solid state power controller in an aircraft, the method comprising:
activating a solid state switching device to provide power on an electrical power bus;
monitoring current flowing in the electrical power bus by determining a voltage developed across a sensing fuse; and
controlling the solid state switching device in dependence upon the monitored voltage.

16. The method of claim 15, wherein controlling the solid state switching device in dependence upon the monitored voltage comprises maintaining a current flowing through the sensing fuse within a predetermined normal operating current range.
